(19) United States
(12) Patent Application Publication
(10) Pub. No.: US 2016/0039084 A1
(43) Pub. Date: Feb. 11, 2016

(54) TOOL PEN WITH DETACHABLE FUNCTION

(71) Applicant: Mininch Inc., Taipei City (TW)

(72) Inventors: Yu-Che Tsai, Taipei City (TW); Yu-Hung Cheng, Taipei City (TW)

(21) Appl. No.: 14/530,823

(22) Filed: Nov. 2, 2014

(30) Foreign Application Priority Data
Aug. 11, 2014 (TW) 103214281

(51) Int. Cl. B25G 1/08; B25G 1/10; B25B 15/02

(52) U.S. Cl. CPC B25G 1/085; B25B 15/02; B25G 1/105

(57) ABSTRACT

A tool pen disclosed in the present invention includes a gathering component, a plurality of screw locking components and a first single-directional constraining mechanism. A first opening is formed on the gathering component. The screw locking components are movably disposed inside the gathering component. The screw locking component includes a body, a locking portion and a first contacting portion. The locking portion is disposed on an end of the body, and the first contacting portion is disposed on a lateral surface of the body. The first single-directional constraining mechanism includes a first slot and a first resilient component. The first slot is formed on an inner wall of the gathering component, and the first resilient component is movably disposed on the first slot. The first resilient component partly protrudes from the first slot and contacts against the first contacting portion of the screw locking component.

### BACKGROUND OF THE INVENTION

1. Field of the Invention

The present invention relates to a tool capable of locking a screw, and more particularly, to a tool pen with detachable function and capable of locking a screw.

2. Description of the Prior Art

A conventional screwdriver includes a handle whereon a screw locking portion is fixed. Each screwdriver has the specific screw locking portion, such as the flathead screwdriver and the Phillips screwdriver. As a plurality of screws or bolts with different specification is applied to the machine apparatus, and an operator has to prepare several screwdrivers to repair the machine apparatus. A set of screwdrivers is heavy and results in an inconvenient drawback. Another conventional screwdriver includes the screw locking portion detachably assembled with the handle; however, the foresaid handle only can be assembled with one screw locking portion, and the operator may take a box full of the screw locking portions with different specification all the time for replacement, so that the conventional detachable screwdriver has drawbacks of troublesome replacement and inconvenient carry.

### SUMMARY OF THE INVENTION

The present invention provides a tool pen with detachable function and capable of locking a screw for solving above drawbacks.

According to the claimed invention, a tool pen with detachable function includes a gathering component, a plurality of screw locking components and a first single-directional constraining mechanism. A first opening is formed on the gathering component. The plurality of screw locking components is movably and detachably disposed inside the gathering component. Each of the plurality of screw locking components includes a body, a locking portion disposed on an end of the body, and a first contacting portion disposed on a lateral surface of the body. The first single-directional constraining mechanism is disposed inside the first opening. The single-directional constraining mechanism includes a first slot formed on an inner wall of the gathering component, and a first resilient component movably disposed on the first slot. A part of the first resilient component is adapted to resiliently protrude from the first slot and contacts against the first contacting portion of the screw locking component stuck out of the first opening, so as to constrain a movement of the screw locking component relative to the gathering component in a first direction.

According to the claimed invention, the part of the first resilient component is resiliently deformed to accommodate inside the first slot, so as to release constraint of the first single-directional constraining mechanism applied to the screw locking component.

According to the claimed invention, the locking portion of the first resilient component protrudes from the first opening to press an external element when the first single-directional constraining mechanism contacts against the first contacting portion.

According to the claimed invention, a second opening is formed on the gathering component and opposite to the first opening. Each of the plurality of screw locking components further includes a second contacting portion disposed on position of the body different from the first contacting portion. The tool pen further includes a second single-directional constraining mechanism disposed inside the second opening. The second single-directional constraining mechanism is adapted to constrain the second contacting portion of the screw locking component adjacent to the second opening, so as to constrain a movement of the screw locking component relative to the gathering component in a second direction opposite to the first direction.

According to the claimed invention, the second single-directional constraining mechanism includes a second slot and a second resilient component. The second slot is formed on position of the inner wall different from the first slot, and the second resilient component is movably disposed on the second slot. A part of the second resilient component is adapted to resiliently protrude from the second slot.

According to the claimed invention, the screw locking component stuck out of the first opening is constrained by the first single-directional constraining mechanism, and the screw locking component adjacent to the second opening is constrained by the second single-directional constraining mechanism, to prevent the plurality of screw locking components from separating from the gathering component through the first opening and the second opening.

According to the claimed invention, the screw locking component stuck out of the first opening contacts against the first single-directional constraining mechanism, the screw locking component adjacent to the second opening contacts against the second single-directional constraining mechanism, and the screw locking components located between the first opening and the second opening are connected with each other in serial connection.

According to the claimed invention, the first slot is a polygonal structure formed around the inner wall, the first resilient component is an arc structure, the arc structure is superimposed with the polygonal structure in part, and the arc structure contacts against the first contacting portion in a multi-touch manner.

According to the claimed invention, each of the plurality of screw locking components further includes an accommodating portion formed on the other end of the body opposite to the locking portion and is adapted to accommodate another screw locking component.

According to the claimed invention, the gathering component is a hollow tubular structure. An inner dimension of the hollow tubular structure is substantially equal to an outer dimension of the body.

According to the claimed invention, a sectional profile of the hollow tubular structure is a polygonal shape, and the body is a polygonal structure corresponding to the sectional profile.

According to the claimed invention, the plurality of screw locking components is detachably disposed inside the gathering component in serial connection.

According to the claimed invention, the tool pen further includes a sheltering component detachably disposed on the gathering component, to shelter the screw locking component stuck out of the gathering component via the first opening.

According to the claimed invention, the sheltering component is assembled with the gathering component by magnetic attraction.

The tool pen of the present invention is utilized to lock/unlock the external element, which can be the screw and the bolt. The screw locking component and the gathering component are preferably made of hard material, such as metal, to prevent the tool pen from damage due to excessive force. The gather component cannot constrain the screw locking component by structural deformation because the gathering is made of metal material, so the present invention disposes two single-directional constraining mechanisms on the front end and the rear end of the gathering component, and resilient deformation and resilient recovery of the resilient component are utilized to partly protrude the resilient component from the slot for interfering constraint. Assembly of the C-ring resilient component and the polygonal slot not only can effectively constrain a movement of the screw locking component, but also can easily release the interfering constraint by the external pulling/pushing force applied to the screw locking component. Comparing to the prior art, the tool pen of the present invention can arbitrarily assemble/disassemble the screw locking component according to actual demand, and has advantages of easy structure, cheap manufacturing cost and convenient operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a tool pen according to an embodiment of the present invention.

FIG. 2 is a sectional view of the tool pen according to the embodiment of the present invention.

FIG. 3 and FIG. 4 respectively are diagrams of a screw locking component in different views according to the embodiment of the present invention.

FIG. 5 and FIG. 6 respectively are diagrams of a gathering component in different views according to the embodiment of the present invention.

FIG. 7 is a front view of the screw locking component according to the embodiment of the present invention.

FIG. 8 is a sectional view of the gathering component according to the embodiment of the present invention.

FIG. 9 is a diagram of the tool pen according to another embodiment of the present invention.

### DETAILED DESCRIPTION

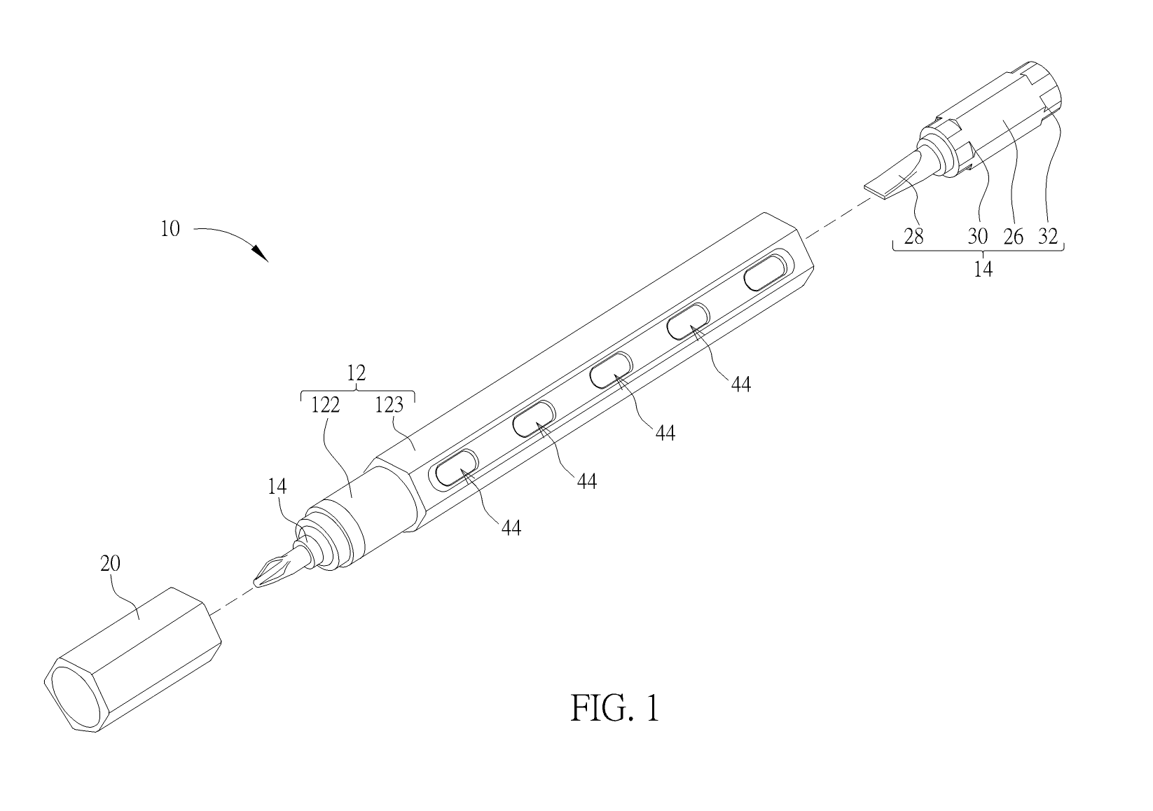

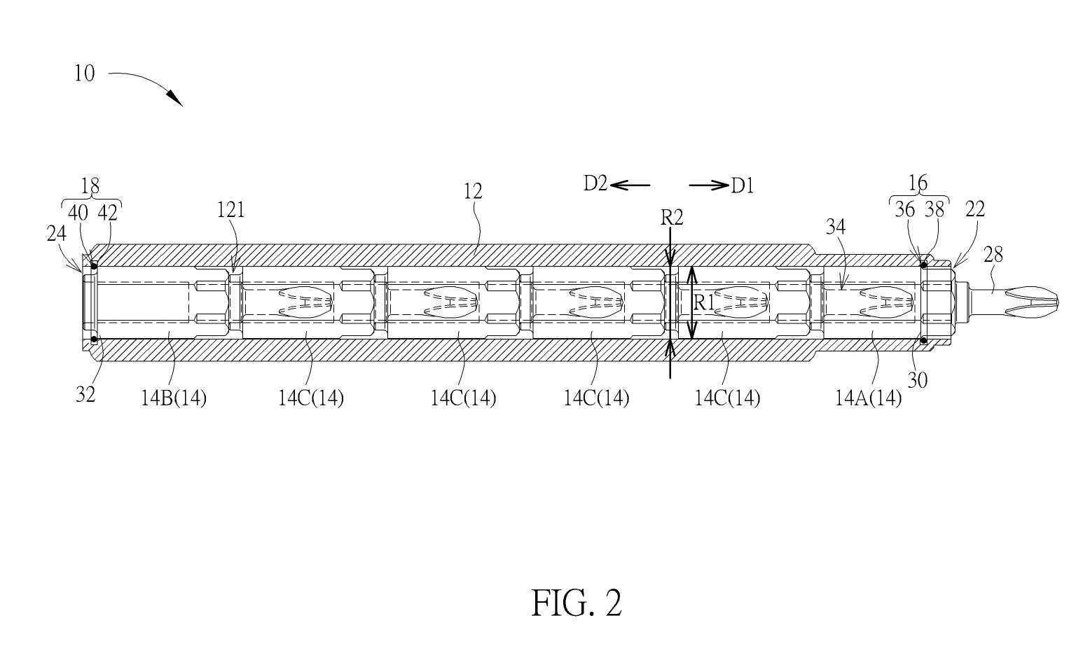

Please refer to FIG. 1 and FIG. 2. FIG. 1 is a diagram of a tool pen 10 according to an embodiment of the present invention. FIG. 2 is a sectional view of the tool pen 10 according to the embodiment of the present invention. The tool pen 10 includes a gathering component 12, a plurality of screw locking components 14, a first single-directional constraining mechanism 16, a second single-directional constraining mechanism 18 and a sheltering component 20. The gathering component 12 is a hollow tubular structure whereinside the plurality of screw locking components 14 is movably and detachably disposed. An amount of the screw locking component 14 corresponds to length difference between the gathering component 12 and the screw locking component 14. A first opening 22 and a second opening 24 are respectively formed on opposite ends of the gather component 12. Generally, the screw locking component 14 moves into the gathering component 12 through the second opening 24 and moves out of the gather component 12 through the first opening 22, however an inverse operation is allowed. The plurality of screw locking components 14 is disposed inside the gathering component 12 in serial connection. The screw locking component 14 stuck out of the first opening 22 can be pulled to separate from the gathering component 12, any of the plurality of screw locking components 14 can be pushed into the gathering component 12 through the second opening 24, each of the plurality of screw locking components 14 has specific specification and the tool pen 10 provides detachable function according to user's demand.

The first single-directional constraining mechanism 16 and the second single-directional constraining mechanism 18 are respectively disposed inside the first opening 22 and the second opening 24. The screw locking component 14 may slide inside the gathering component 12 in a first direction D1 by gravity since the tool pen 10 is not horizontally arranged, such as arranged vertically or obliquely, and the first single-directional constraining mechanism 16 contacts against the screw locking component 14, which is partly stuck out of the first opening 22, to prevent the foresaid screw locking component 14 from accidentally separating from the gathering component 12. As the tool pen 10 presses an external element, the screw locking components 14 disposed inside the gathering component are pushed in a second direction D2, and the second single-directional constraining mechanism 18 contacts against the screw locking component 14 adjacent to the second opening 24 to prevent the whole screw locking components 14 from separating from the gathering component 12. The second direction D2 is substantially opposite to the first direction D1.

The sheltering component 20 is detachably disposed on the gathering component 12. For example, the sheltering component 20 can be disposed on an end of the gathering component 12 whereon the first opening 22 is formed to shelter the screw locking component 14 stuck out of the first opening 22, and the sheltering component 20 can be assembled with the gathering component 12 by magnetic attraction, elastic engagement or any detachable manner. The sheltering component 20 further can be assembled with the other end of the gathering component 12 whereon the second opening 24 is formed by the magnetic attraction, the elastic engagement or any detachable manner, so as to avoid misplacement of the sheltering component 20 and separation of the screw locking component 14 from the gathering component 12 through the second opening 24. It is to say, the second single-directional constraining mechanism 18 is an optional unit and can be replaced by the sheltering component 20.

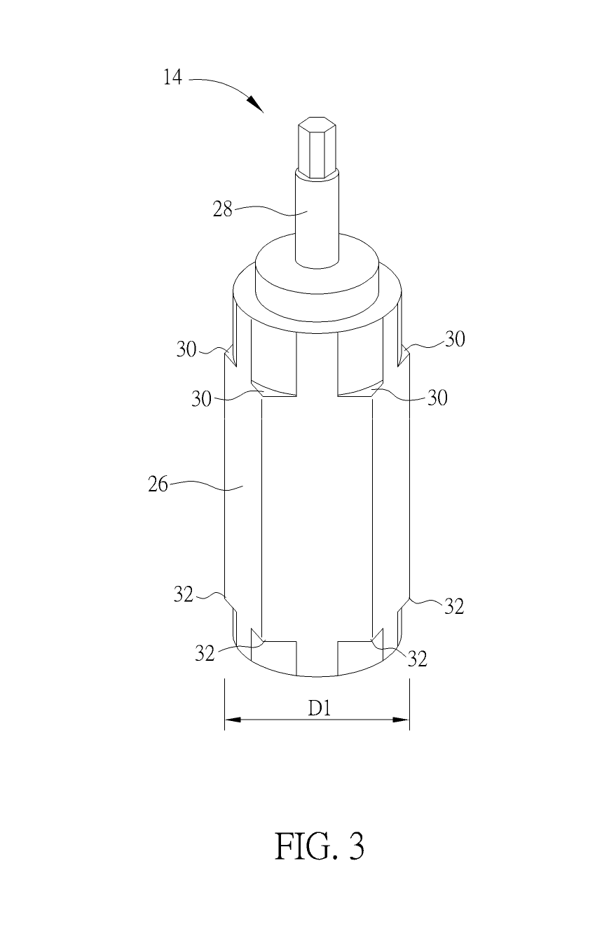

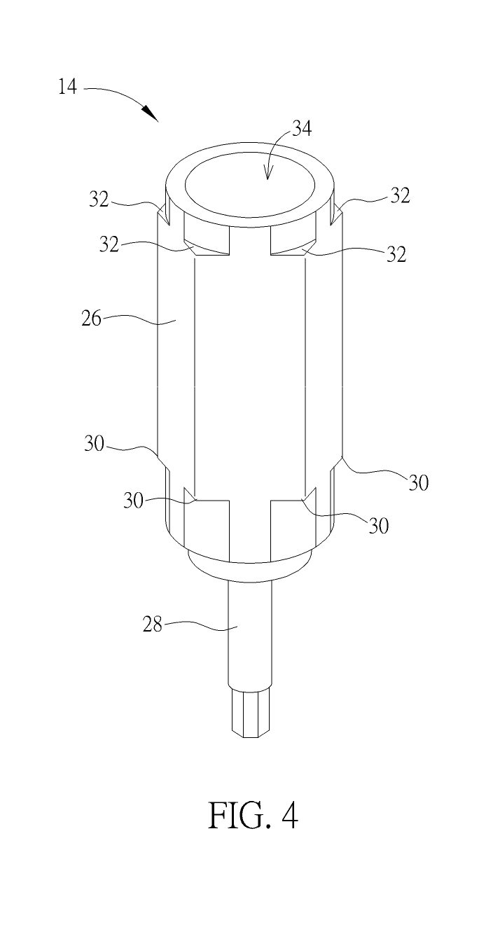

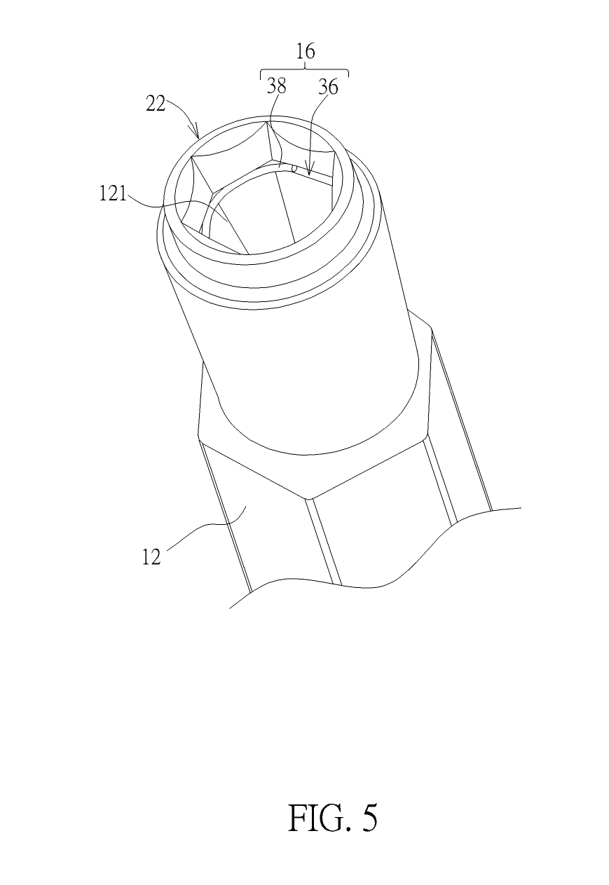

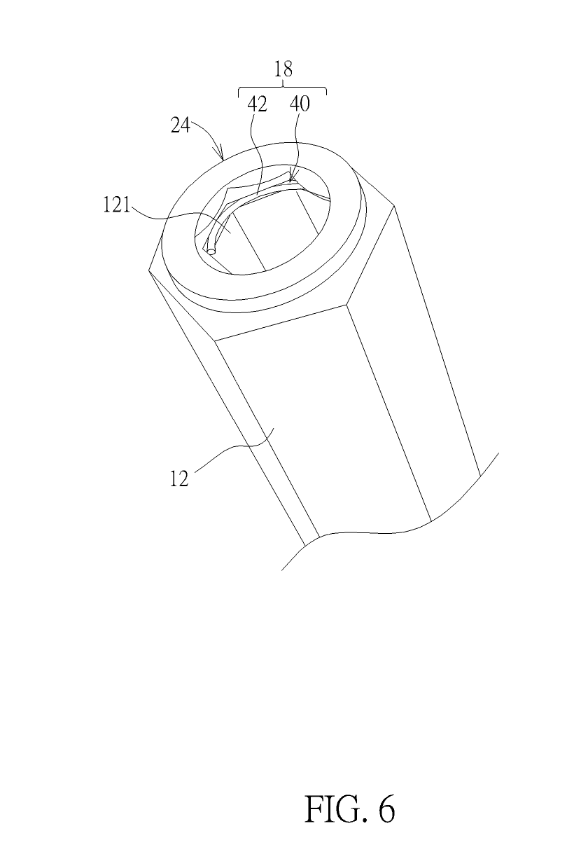

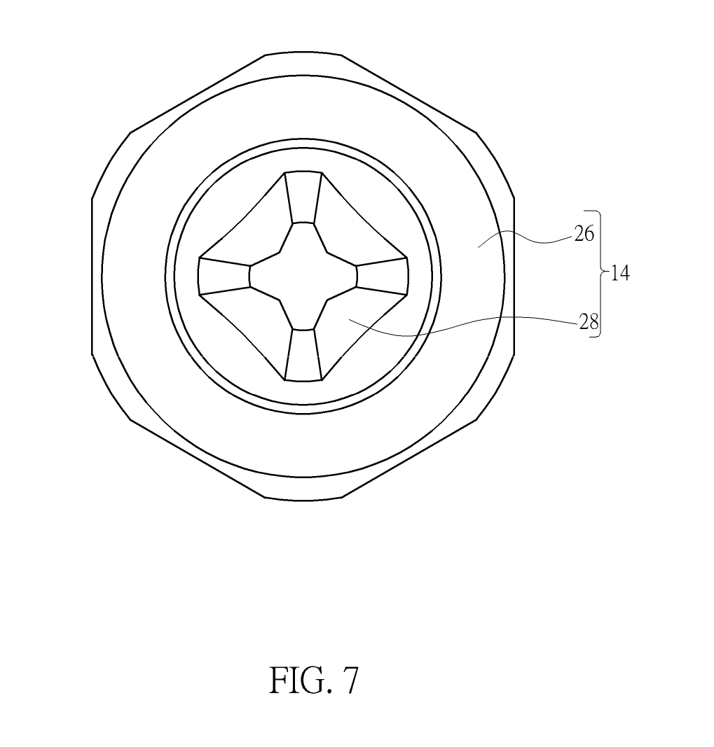

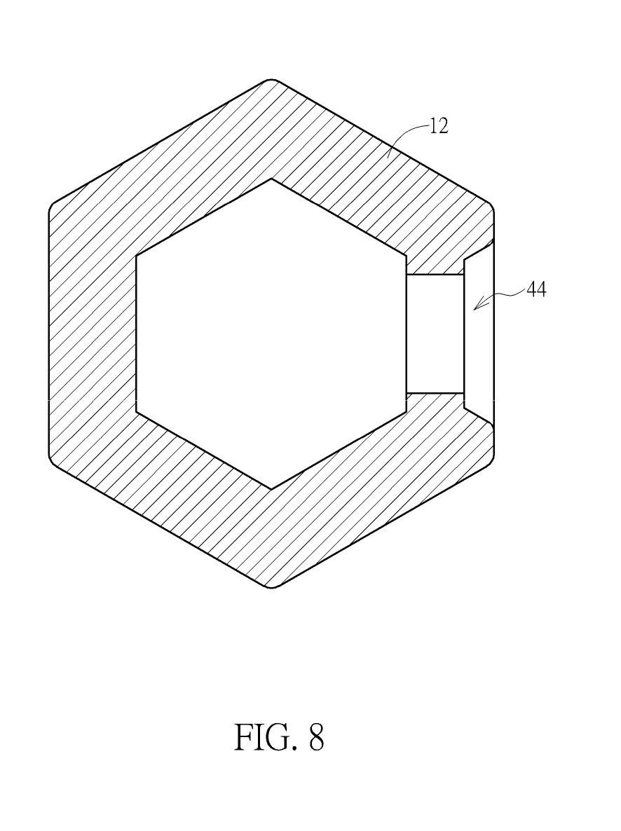

Please refer to FIG. 3 to FIG. 8. FIG. 3 and FIG. 4 respectively are diagrams of the screw locking component 14 in different views according to the embodiment of the present invention. FIG. 5 and FIG. 6 respectively are diagrams of the gathering component 12 in different views according to the embodiment of the present invention. FIG. 7 is a front view of the screw locking component 14 according to the embodiment of the present invention. FIG. 8 is a sectional view of the gathering component 12 according to the embodiment of the present invention. Each of the plurality of screw locking components 14 includes a body 26, a locking portion 28, a first contacting portion 30, a second contacting portion 32 and an accommodating portion 34. An outer dimension R1 of the body 26 is substantially equal to an inner dimension R2 of the gathering component 12 (which is a hollow tubular structure), as shown in FIG. 2 and FIG. 3. A sectional profile of the gathering component 12 is a polygonal shape (such as a hexagon shape), and the body 26 is a polygonal structure (such as a hexagon structure) corresponds to the sectional profile of the gathering component 12, as shown in FIG. 8, so that the screw locking component 14 inside the gathering component 12 does not revolve on a vertical axle of the tool pen 10 along its structural length.

The locking portion 28 and the accommodating portion 34 are respectively disposed on opposite ends of the body 26. The locking portion 28 is a protruding structure to engage with the external element (such as the screw or the bolt) for rotation, and the external element can be locked into or unlocked from a corresponding structure (such as the threaded hole or the screw nut). The accommodating portion 34 is a sunken structure to accommodate the locking portion 28 of the adjacent screw locking component 14, so that the plurality of screw locking components 14 can be partly stacked with each other in the serial connection. The first contacting portion 30 and the second contacting portion 32 may be blocks formed on opposite ends of the lateral surface of the body 26. When the screw locking component 14 passes through the first opening 22, the first single-directional constraining mechanism 16 contacts against the first contacting portion 30 to generate structural interference; when the screw locking component 14 passes through the second opening 24, the second single-directional constraining mechanism 18 contacts against the second contacting portion 32 to generate structural interference, so as to prevent the screw locking components 14 from separating from the gathering component 12.

The first single-directional constraining mechanism 16 is disposed inside the first opening 22, as shown in FIG. 5. The first single-directional constraining mechanism 16 includes a first slot 36 and a first resilient component 38. The first slot 36 is formed around an inner wall 121 of the gathering component 12, and the first resilient component 38 is movably disposed on the first slot 36. The second single-directional constraining mechanism 18 is disposed inside the second opening 24, as shown in FIG. 6. The second single-directional constraining mechanism 18 includes a second slot 40 and a second resilient component 42. The second slot 40 is formed on position of the inner wall 121 different from the first slot 36, and the second resilient component 42 is movably disposed on the second slot 40. Shapes of the first slot 36 and the second slot 40 are hexagon structure corresponding to the sectional profile of the gathering component 12. The first resilient component 38 and the second resilient component 42 preferably are arc structures, such as the C-ring. The first resilient component 38 does not completely overlap the first slot 36 since the first resilient component 38 is disposed on the first slot 36, which means the first resilient component 38 is superimposed with the first slot 36 in part, and a part of the first resilient component 38 resiliently protrudes from the first slot 36 to contact against the first contacting portion 30 of the screw locking component 14 in a multi-touch manner. As mentioned above, a part of the second resilient component 42 can resiliently protrude from the second slot 40 to contact against the second contacting portion 32 of the screw locking component 14 in the multi-touch manner. Thus, movements of the screw locking component 14 relative to the gathering component 12 in the first direction D1 and the second direction D2 are effectively constrained.

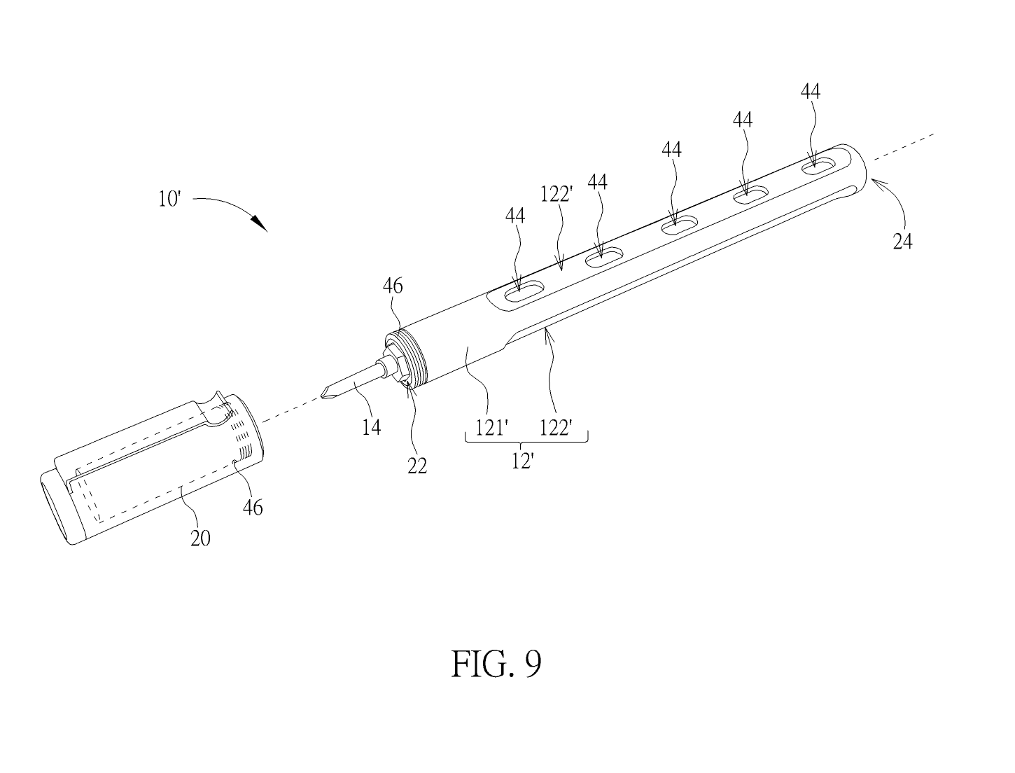

Please refer to FIG. 9. FIG. 9 is a diagram of the tool pen 10′ according to another embodiment of the present invention. Difference between the two embodiments is the tool pen 10′ includes the narrowed gathering component 12′. As shown in FIG. 1, the gathering component 12 includes a cylinder tube 122 and a polygonal handle 123, and dimensions of the polygonal handle 123 are greater than dimensions of the cylinder tube 122. As shown in FIG. 9, material of a narrowed space 122′ is removed from a cylinder tube 121′, which means a part of the cylinder tube 121′ is pared off to thin the gathering component 12′, and a width and a weight of the tool pen 10′ can be decreased accordingly. The gathering component 12′ preferably has three narrowed space 122′ symmetrically formed on different orientation of the cylinder tube 121′. An area of the cylinder tube 121′ adjacent to the first opening 22 does not have the narrowed space 122′ because the first slot 36 (not shown in FIG. 9) is formed. Further, thread structures 46 are respectively disposed on the front end of the gathering component 12′ and disposed inside the sheltering component 20. This embodiment shows the sheltering component 20 is assembled with and disassembled from the gathering component 12′ by rotatable screwing combination.

Each of the plurality of screw locking components 14 has the specific specification formed on its locking portion 28, and is slidably connected with each other in the serial connection inside the gathering component 12. As shown in FIG. 2, the plurality of screw locking components 14 includes the front screw locking component 14A, the rear screw locking component 14B and the middle screw locking components 14C. The front screw locking component 14A contacts against the first single-directional constraining mechanism 16, which means the first contacting portion 30 of the front screw locking component 14A is blocked by the first single-directional constraining mechanism 16 to prevent the front screw locking component 14A from separating from the gathering component 12. The locking portion 28 of the front screw locking component 14A protrudes from the first opening 22 and can be utilized to press/rotate the external element (such as the screw or the bolt). The rear screw locking component 14B contacts against the second single-directional constraining mechanism 18 and does not move out of the gathering component 12 by constraint. The middle screw locking components 14C are connected between the front screw locking component 14A and the rear screw locking component 14B. The front screw locking component 14A and the rear screw locking component 14B are respectively blocked by the first single-directional constraining mechanism 16 and the second single-directional constraining mechanism 18, so the whole screw locking components 14 cannot move out of the gathering component 12 through the first opening 22 and the second opening 24.

For practicing the detachable function of the tool pen 10, the front screw locking component 14A can be pulled in the first direction D1, the front screw locking component 14A drives the first resilient component 38 to generate resilient deformation, the part of the first resilient component 38 initially protrude from the first slot 36 is pressed to accommodate inside the first slot 36, the first single-directional constraining mechanism 16 does not constrain the front screw locking component 14A, and the front screw locking component 14A can be pulled out of the gathering component 12 through the first opening 22. The front screw locking component 14A pulled out of the gathering component 12 further can be pushed into the gather component 12 through the second opening 24, and then press the rear screw locking component 14B and the middle screw locking components 14C to slide inside the gathering component 12 in the first direction D1 until the locking portion 28 of one of the middle screw locking components 14C protrudes from the first opening 22. In the meantime, the part of the first resilient component 38 is recovered to partly protrude from the first slot 36, and the foresaid middle screw locking component 14C is constrained by the first single-directional constraining mechanism 16 and cannot move out of the gathering component 12 through the first opening 22.

It should be mentioned that a plurality of holes 44 can be formed on the gathering component 12, as shown in FIG. 2. An amount of the hole 44 corresponds to an amount of the screw locking component 14. A mark may be printed on the body 26 of each screw locking component 14 to indicate the specification of the related locking portion 28, for example, the mark indicates a style or a dimension of the each screw locking component 14. The user can watch the mark of the screw locking component 14 disposed inside the gathering component via the hole 44 for convenient utilization and easy replacement.

The tool pen of the present invention is utilized to lock/unlock the external element, which can be the screw and the bolt. The screw locking component and the gathering component are preferably made of hard material, such as metal, to prevent the tool pen from damage due to excessive force. The gather component cannot constrain the screw locking component by structural deformation because the gathering is made of metal material, so the present invention disposes two single-directional constraining mechanisms on the front end and the rear end of the gathering component, and resilient deformation and resilient recovery of the resilient component are utilized to partly protrude the resilient component from the slot for interfering constraint. Assembly of the C-ring resilient component and the polygonal slot not only can effectively constrain a movement of the screw locking component, but also can easily release the interfering constraint by the external pulling/pushing force applied to the screw locking component. Comparing to the prior art, the tool pen of the present invention can arbitrarily assemble/disassemble the screw locking component according to actual demand, and has advantages of easy structure, cheap manufacturing cost and convenient operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A tool pen with detachable function, the tool pen comprising:
a gathering component whereon a first opening is formed;
a plurality of screw locking components movably and detachably disposed inside the gathering component, each of the plurality of screw locking components comprising:
a body;
a locking portion disposed on an end of the body; and
a first contacting portion disposed on a lateral surface of the body; and
a first single-directional constraining mechanism disposed inside the first opening, the single-directional constraining mechanism comprising:
a first slot formed on an inner wall of the gathering component; and
a first resilient component movably disposed on the first slot, a part of the first resilient component being adapted to resiliently protrude from the first slot and contacting against the first contacting portion of the screw locking component stuck out of the first opening, so as to constrain a movement of the screw locking component relative to the gathering component in a first direction.

2. The tool pen of claim 1, wherein the part of the first resilient component is resiliently deformed to accommodate inside the first slot so as to release constraint of the first single-directional constraining mechanism applied to the screw locking component.

3. The tool pen of claim 1, wherein the locking portion of the first resilient component protrudes from the first opening to press an external element when the first single-directional constraining mechanism contacts against the first contacting portion.

4. The tool pen of claim 1, wherein a second opening is formed on the gathering component and opposite to the first opening, each of the plurality of screw locking components further comprises a second contacting portion disposed on position of the body different from the first contacting portion, the tool pen further comprises a second single-directional constraining mechanism disposed inside the second opening, the second single-directional constraining mechanism is adapted to constrain the second contacting portion of the screw locking component adjacent to the second opening, so as to constrain a movement of the screw locking component relative to the gathering component in a second direction opposite to the first direction.

5. The tool pen of claim 4, wherein the second single-directional constraining mechanism comprises a second slot and a second resilient component, the second slot is formed on position of the inner wall different from the first slot, the second resilient component is movably disposed on the second slot, and a part of the second resilient component is adapted to resiliently protrude from the second slot.

6. The tool pen of claim 4, wherein the screw locking component stuck out of the first opening is constrained by the first single-directional constraining mechanism, and the screw locking component adjacent to the second opening is constrained by the second single-directional constraining mechanism, to prevent the plurality of screw locking components from separating from the gathering component through the first opening and the second opening.

7. The tool pen of claim 4, wherein the screw locking component stuck out of the first opening contacts against the first single-directional constraining mechanism, the screw locking component adjacent to the second opening contacts against the second single-directional constraining mechanism, and the screw locking components located between the first opening and the second opening are connected with each other in serial connection.

8. The tool pen of claim 1, wherein the first slot is a polygonal structure formed around the inner wall, the first resilient component is an arc structure, the arc structure is superimposed with the polygonal structure in part, and the arc structure contacts against the first contacting portion in a multi-touch manner.

9. The tool pen of claim 1, wherein each of the plurality of screw locking components further comprises an accommodating portion formed on the other end of the body opposite to the locking portion and is adapted to accommodate another screw locking component.

10. The tool pen of claim 1, wherein the gathering component is a hollow tubular structure, an inner dimension of the hollow tubular structure is substantially equal to an outer dimension of the body.

11. The tool pen of claim 10, wherein a sectional profile of the hollow tubular structure is a polygonal shape, and the body is a polygonal structure corresponding to the sectional profile.

12. The tool pen of claim 1, wherein the plurality of screw locking components is detachably disposed inside the gathering component in serial connection.

13. The tool pen of claim 1, further comprising:
a sheltering component detachably disposed on the gathering component to shelter the screw locking component stuck out of the gathering component via the first opening.

14. The tool pen of claim 13, wherein the sheltering component is assembled with the gathering component by magnetic attraction.
